(19) United States
(12) Patent Application Publication
(10) Pub. No.: US 2008/0074023 A1
(43) Pub. Date: Mar. 27, 2008

(54) More energy efficient light bulb

(76) Inventor: Charles Bert Hickman, Palmdale, CA (US)

Correspondence Address: CHARLES BERT HICKMAN, 3817 SOUTHVIEW COURT, PALMDALE, CA, 93550, US

(21) Appl. No.: 11/526,905

(22) Filed: Sep. 26, 2006

(51) Int. Cl. H01J 61/40

(52) U.S. Cl. 313/112

(57) ABSTRACT

An improved method of increasing the energy efficiency of the incandescent light bulb and other electrically stimulated optical radiation sources is disclosed. By employing dichroic beamsplitter type technology, visible light can be seen while much unused infrared radiation energy from the incandescent filament can be returned to the incandescent filament thus requiring less electrical energy input to maintain the filament in the incandescent condition.

### BACKGROUND OF THE INVENTION

This patent relates in general to illumination sources such as light bulbs. The ordinary tungsten filament light bulb is inexpensive to fabricate, but highly inefficient; a large part of the input energy is used to produce optical energy frequencies that are not visible. This excess optical energy is not only not useful for visual illumination, but produces excess heat that taxes air conditioning systems.

There exist classes of optical materials that substantially allow some optical frequencies to pass through while simultaneously substantially reflecting other optical frequencies. They go by various names such as: dichroic mirror, dichroic beamsplitter, hot mirror, etc. Yet, they all allow the transmission of some optical frequencies while reflecting others. Oftentimes, they are created by coating various substrates such as glass or quartz. For ease of reference herein, materials that perform these dual optical functions shall be referred to as reflectotransmissive materials, and the properties of such materials shall referred to simply as reflectotransmissive. Additionally it should be noted that with proper construction single or multiple bandwidth reflection functions can be achieved within optical frequencies of interest.

For the ordinary light bulb illustration, it would be desirable if reflectotransmissive material could be used to transmit the visible light from the filament while returning undesirable energy such as infrared energy back to the filament.

### BRIEF SUMMARY OF THE INVENTION

The present invention uses reflectotransmissive material to transmit desired optical energy from an electrically simulated optical source such as an incandescent filament while reflecting undesirable optical energy back to the filament. This returned optical energy is added back to the filament total energy; thus less electrical energy is required to keep the filament in an incandescent condition. Additionally, a substantial amount of excess optical energy is kept out of the surrounding environment creating a saving for air conditioning systems.

### BRIEF DESCRIPTION OF THE DRAWINGS

FIG. 1 depicts the end views of three potential shapes for reflectotransmissive hollow tubes into which an optical filament is inserted.

FIG. 2 is a concept drawing to depicts the side view a reflectotransmissive hollow tube with an incandescent element inserted.

FIG. 3 depicts a way in which reflectotransmissive material may be used in conjunction with an ordinary parabolic reflector.

### DETAILED DESCRIPTION OF THE INVENTION

A more energy efficient method for optical radiation generation is disclosed. In the following description for purposes of explanation, a number of details are set forward to provide a through understanding of the present invention. However, it will be apparent to one ordinarily skilled in the art that these details are not required in order to practice the invention.

For simplicity and to allow for a thorough understanding of the present invention, an explanation will be given as to how the present invention could apply to an incandescent light bulb filament as an example of an electrically stimulated optical radiation source. However, this should not be considered to automatically preclude the use of other electrically stimulated optical radiation sources (e.g. vapors, gases, etc.) with the present invention. Additionally, the present invention is concerned with a method to improve the energy efficiency of electrically stimulated optical radiation sources within given applications, and is not normally concerned with the details of the operation, structure or materials used for any given application (e.g. incandescent light bulb, fluorescent tube, etc.); adequate information exists for that purpose. Therefore, any such details contained herein shall only be those deemed desirable for explaining the present invention.

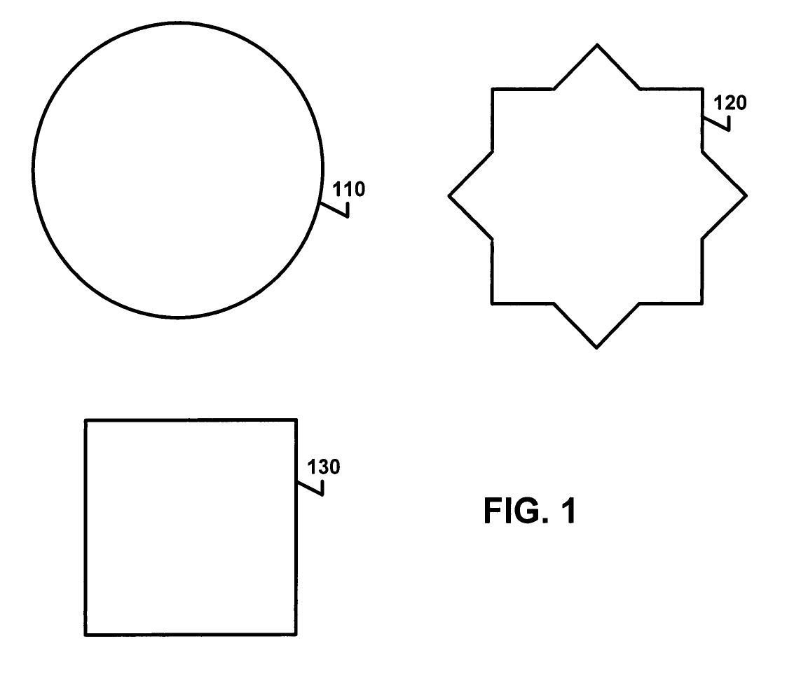

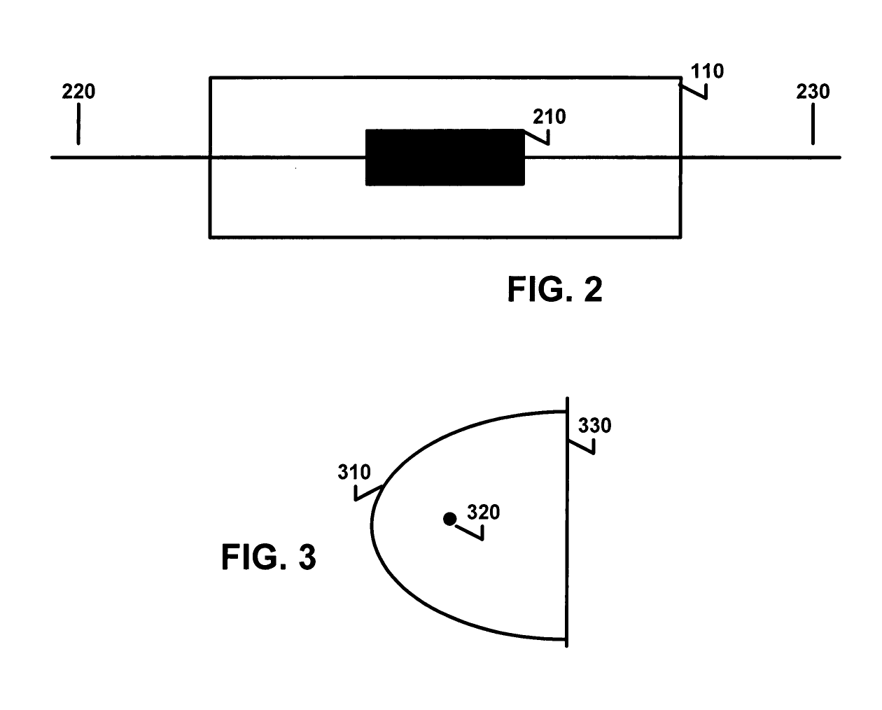

FIG. 1 depicts the end view of some preferred shapes (110, 120, 130) for reflectotransmissive tubes to be employed with an incandescent filament. The tube 110 is longer than the filament 210 (FIG. 2). The filament 210 is placed lengthwise into the hollow tube with wire conductors 220, 230 attached to filament 210. It is desirable that the hot filament 220 not touch the sides of the reflectotransmissive tube 110. This tube 110 is constructed with a glass substrate; therefore, each end can be melted and pinched together against the conductors 220, 230 in order to maintain the position of the filament 210. Additionally, the pinched ends of the tube 110 could allow the tube 110 alone to be filled with any gas or gases which would be deemed desirable to be used with the filament 210; otherwise, the pinched ends may not be required to be gas tight.

For this application the reflectotransmissive tube 110 allows visible light to be substantially transmitted (pass through) while substantially reflecting the infrared radiation energy back to the incandescent filament 210 thus requiring less electrical energy to maintain the incandescence condition of the filament 210.

FIG. 3 depicts how the present invention could be used to create a green directional light. Incandescent filament 320 is at the focus point of a parabolic reflector 310 and its optical energy is sent to reflectotransmissive plate 330. Plate 330 acts as a bandpass filter; blue, red and infrared radiation energy is substantially reflected back to the filament 320 via the parabolic mirror 310. Only the green light in the visible spectrum is substantially transmitted (passed through) by the plate 330.

Reflectotransmissive materials can be constructed to pass a number of optical frequencies that do not have to be contiguous in nature. Additionally, reflectotransmissive material can be constructed to reflect a number of optical frequencies that do not have to be contiguous; for example, it could substantially pass red and blue visible light while substantially reflecting green light, and ultraviolet and infrared radiation. One ordinarily skilled in the art could determine that combinations of mirrors, fiber optic cables, and other optical devices could be employed as a part of the present invention. Finally, a fluorescent lamp does not employ the same optical radiation frequencies from its optical radiation source as an incandescent source; but this invention still applies. Both desired and undesired optical radiation frequencies are emitted from its electrically stimulated optical radiation source.

What is claimed is:

1. Method for improving the energy efficiency of an optical energy radiator source comprising:
A) an electrically stimulated optical radiation source;
B) reflectotransmissive means being placed physically in proximity to the optical radiation source a manner such that a substantial amount of desired optical radiation frequencies from the optical radiation source are transmitted and a substantial amount of undesired optical radiation frequencies from the optical radiation source are reflected back to the optical radiation source.

2. The method of claim 1 wherein the optical radiation source is an incandescent element.

3. The method of claim 1 wherein the optical radiation source is an incandescent element, the desired optical radiation is substantially visible light, and undesirable optical radiation is substantially infrared radiation.

4. The method of claim 1 wherein the desired optical radiation frequencies create the visible color violet.

5. The method of claim 1 wherein the desired optical radiation is a mixture of visible light frequencies.

6. The method of claim 1 wherein the optical radiation source is a mercury vapor.

7. Method for improving the energy efficiency of an optical energy radiator source comprising:
A) an electrically stimulated optical radiation source;
B) a relatively efficient optical direction changing means that changes the direction of the radiated optical energy from the optical radiation source.
C) reflectotransmissive means being placed physically in a significant portion of the path of the radiated optical energy from the optical direction changing means so that a substantial amount of desired optical radiation frequencies from the optical radiation source are transmitted and a substantial amount of undesired optical radiation frequencies from the optical radiation source are reflected back to the optical radiation source via the optical direction changing means.
